(19) United States
(12) Patent Application Publication
(10) Pub. No.: US 2004/0254683 A1
(43) Pub. Date: Dec. 16, 2004

(54) Home gateway system with power management function

(75) Inventor: Giu-yeol Kim, Yeongtong-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/793,649

(22) Filed: Mar. 5, 2004

(30) Foreign Application Priority Data
Mar. 7, 2003 (KR) 10-2003-0014277

(51) Int. Cl. G05D 11/00

(52) U.S. Cl. 700/286

(57) ABSTRACT

A home gateway system having a power management function includes function modules for controlling electrical/electronic products at home by function and a power supply for supplying electrical power to the function modules. The home gateway system further includes a signal input unit for externally receiving a control signal; a control unit for generating a power control signal for controlling the power applied to the respective function modules in response to the control signal, generating a standby setting signal for setting the respective function modules into a standby state, and selectively applying the standby setting signal to the respective function modules; and a power switching unit for turning the respective function modules on or off in response to the power control signal. Accordingly, the home gateway system can selectively turn off or on individual function modules, and set or release inactive function modules to or from the standby state.

### CROSS-REFERENCE TO RELATED APPLICATIONS

This application claims the benefit of Korean Patent Application No. 10-2003-0014277, dated Mar. 7, 2003, in the Korean Intellectual Property Office, the disclosure of which is incorporated herein by reference.

### BACKGROUND OF THE INVENTION

1. Field of the Invention

Systems and methods consistent with the present invention relate to a home gateway system, and more particularly to, a home gateway system having a power management function and a power control method.

2. Description of the Related Art

A home gateway system operates to establish home automation by controlling through a network various electronic products at home, such as television sets, video devices, refrigerators, washing machines, air conditioners, and satellite broadcasting receivers. The home gateway system is provided with function modules for classifying various electronic products at home by function and controlling the products. The home gateway system needs a backbone network for connecting the function modules to the network. For example, function modules that are classified into a broadcast reception module, a video/audio module and a home network module for controlling home electronic products such as refrigerators and washing machines, in addition to control devices such as personal computers have been used for home gateways.

FIG. 1 is a block diagram for showing a conventional home gateway system.

The home gateway system shown in FIG. 1 has a broadcast reception module 10, a video/audio module 20, a network module 30, a home network module 40, a main control unit 50, and a power supply 60.

The broadcast reception module 10 has a built-in tuner (not shown) to receive skywave broadcast signals and cable broadcast signals. The broadcast reception module 10 does not interact with electrical and electronic products at home, but has hardware provided for broadcast receptions independently from the products.

The video/audio module 20 interacts with audio and video (A/V) devices such as television sets, video devices, DVD devices, and audio devices, and so on, which are set up at home. The video/audio module 20 receives or processes video and audio signals from the devices, and transmits the signals to the television sets or video devices. For example, if a video/audio signal in the MPEG format is applied to the video/audio module 20 from a DVD device, the video/audio module 20 MPEG-decodes the video/audio signal, converts the MPEG-decoded signal into an NTSC-formatted signal that a television set can receive, and transmits the NTSC-formatted signal to the television set for display.

The network module 30 is a module for connecting a home gateway system to an external network (e.g., the Internet), and has a cable modem or an Ethernet card for high-speed communications in general.

The home network module 40 is a module for connecting to and controlling electronic products at home, and has interfaces such as IEEE 1394, USB, HOME PNA, and so on. Such interfaces enable the home network module 40 to communicate data with the electronic products at home. In a case that the home network module 40 has a USB interface, electronic products may also have the USB interface for interfacing with the home network module 40.

The main control unit 50 performs overall control of the components of the home gateway system, that is, the broadcast reception module 10, video/audio module 20, network module 30, and home network module 40, and controls data flows among the individual function modules 10 to 40.

For example, if a user wishes to watch a broadcast program received by the broadcast reception module 10, the user has a broadcast signal, which is outputted from the broadcast reception module 10, applied to the video/audio module 20, or monitors operation states of home electronic products connected to the home network module 40.

The power supply 60 applies electric power to the components 10 to 50 constructing the home gateway system. Here, power from the power supply 60 must be continuously provided so that the network module 30 and the home network module 40 are kept working all day long. Since the home gateway system has to be enabled to monitor the states of home electronic products all the time, the home network module 40 monitoring the home electronic products has to be kept turned on all the time. Also, since a user has to connect to the external network through the network module 30 when he or she wishes to control the home gateway system through the external network, the network module 30 has to be kept turned on all the time as well. In the meantime, the broadcast reception module 10 and the video/audio module 20 are connected to A/V devices at home, but these A/V devices, unlike the other electronic products connected to the home network module 40, are not required to be monitored all the time. It is enough for the A/V devices to be kept turned on during their operations and turned off otherwise. In general, the broadcast reception module 10 operates a few hours or so a day, and the A/V devices such as video and DVD devices operate for fewer hours. The broadcast reception module 10 has a tuner (not shown), a signal processing unit (not shown), an audio signal amplifier (not shown), and so on, and these components consume more power than the other function modules do. That is, the conventional home gateway system has a disadvantage of wasting power unnecessarily since a user can turn on and off the entire home gateway system, but not selectively turn off unnecessarily activating function modules so that function modules not in use keep activated all the time.

### SUMMARY OF THE INVENTION

Illustrative embodiments of the present invention may, but are not required to, solve the above and/or other problems. It is an exemplary aspect of the present invention to provide a home gateway system capable of efficiently managing electric power thereof.

In order to achieve the above exemplary aspect, a home gateway system having a power management function that includes at least one or more function modules controlling electrical and electronic products at home by function and a power supply for supplying electric power to the function modules, according to the present invention, comprises a signal input unit for externally receiving a control signal; a control unit for generating a power control signal for controlling the power applied to the respective function modules in response to the control signal, generating a standby setting signal for setting the respective function modules into a standby state, and selectively applying the standby setting signal to the respective function modules; and a power switching unit for turning the respective function modules on or off in response to the power control signal.

The control unit includes a monitoring unit for selectively applying the power control signal to the respective function modules in response to the control signal, and checking the operation states of the respective function modules in a predetermined time interval; and a standby control unit for applying the standby setting signal to function modules selected based on a result of the check of the monitoring unit and the control signal applied to the signal input unit.

Preferably, but not necessarily, the control unit has driver programs for driving the respective function modules, and the driver programs are applied to the selected function modules together with the standby setting signal.

Preferably, but not necessarily, the function modules each have a register for setting an operation condition thereof, the driver programs are loaded into the control unit, and a function module is set to a standby state when the standby setting signal is applied to the register of the function module.

Preferably, but not necessarily, the control signal is externally generated by one of a wired and a wireless control device.

Preferably, but not necessarily, the wired control device is a power setting key provided on each of the function modules and/or a remote personal computer for controlling the function modules through the network.

Preferably, but not necessarily, the wireless control device is any of a remote controller, a mobile electronic device, and a remote personal computer for controlling the function modules through a wireless network.

Consistent with the above exemplary object, a power control method for a home gateway system having one or more function modules for controlling electrical and electronic products at home by function and a power supply for supplying electric power to the function modules, according to the present invention, comprises the steps of receiving a control signal externally; generating a standby setting signal corresponding to the received control signal; and selectively applying the standby setting signal to the function modules.

Preferably, but not necessarily, the step of externally receiving the control signal further includes a step of selectively supplying the power to the respective function modules in response to the control signal.

Preferably, but not necessarily, the step of generating the standby setting signal further includes the steps of checking operation states of the respective function modules in a predetermined time interval; and applying the standby setting signal to inactive function modules of the function modules according to a result of the check.

Hereinafter, the present invention will be described in detail with reference to the attached drawings.

### BRIEF DESCRIPTION OF THE DRAWINGS

The invention will be described in detail with reference to the following drawings in which like reference numerals refer to like elements, and wherein:

FIG. 1 is a block diagram for showing a conventional home gateway system;

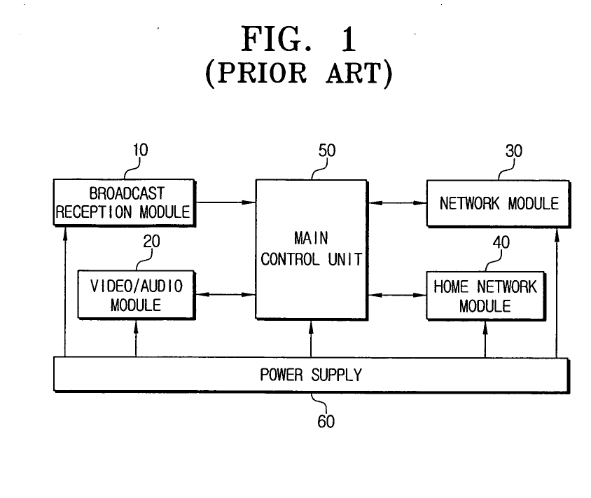

FIG. 2 is a block diagram for showing a home gateway system according to an illustrative embodiment of the present invention;

FIG. 3 is a block diagram for showing the main control unit of FIG. 2 in detail; and

FIG. 4 is a flow chart for showing a power control method for a home gateway system according to an illustrative embodiment of the present invention.

### DETAILED DESCRIPTION OF THE ILLUSTRATIVE EMBODIMENTS

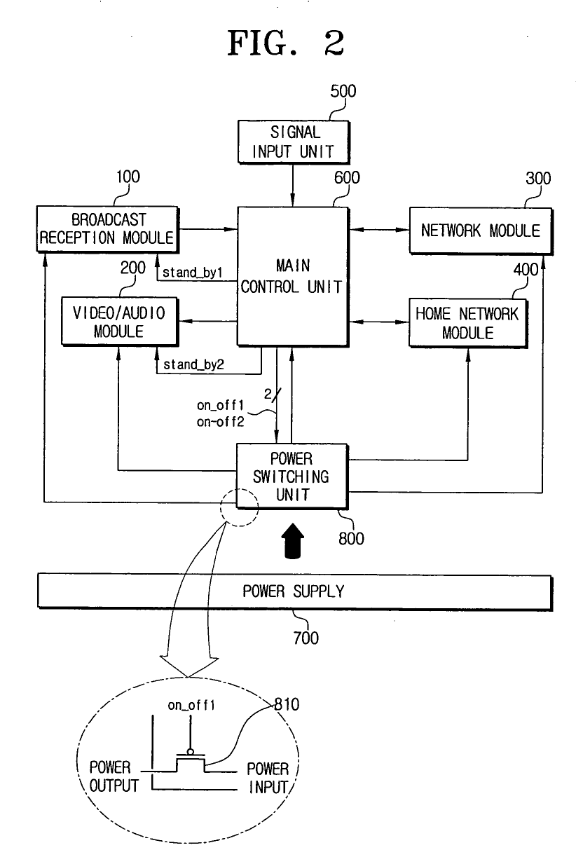

FIG. 2 is a block diagram for showing a home gateway system according to an illustrative embodiment of the present invention.

The home gateway system shown in FIG. 2 has a broadcast reception module 100, a video/audio module 200, a network module 300, a home network module 400, a signal input unit 500, a main control unit 600, a power supply 700, and a power switching unit 800.

The broadcast reception module 100 has a built-in tuner (not shown) for receiving skywave and cable broadcast signals. The broadcast reception module 100 does not interact with electrical and electronic products at home, and has hardware for receiving broadcasts independently from the products.

The video/audio module 200 interacts with A/V devices such as television sets, video devices, DVD devices, audio devices, and so on, which are set up at home. The video/audio module 200 receives or processes video and audio signals from the devices, and transmits the signals to the television sets or video devices. For example, if a video/audio signal in the MPEG format is applied to the video/audio module 200 from a DVD device, the video/audio module 200 MPEG-decodes the video/audio signal, converts the MPEG-decoded signal into an NTSC-formatted signal that a television set can receive, and transmits the NTSC-formatted signal to the television set for display.

The network module 300 is a module for connecting a home gateway system to an external network (e.g., the Internet), and has a cable modem or an Ethernet card for high-speed communications in general.

The home network module 400 is a module for connecting to and controlling electronic products at home, and has interfaces such as IEEE 1394, USB, HOME PNA, and so on. Such interfaces enable the home network module 400 to communicate data with the electronic products at home. For example, in a case that the home network module 400 has a USB interface, electronic products may also have the USB interface for interfacing with the home network module 400.

The signal input unit 500 receives controls signals applied from various control units to remotely control the home gateway system according to the present invention. Remote controllers, Personal Digital Assistants (PDAs), mobile electronic devices such as cellular phones, remote personal computers for controlling the home gateway system through wired/wireless networks, and so on, are examples of the control units capable of applying the control signals. Here, if a user wishes to control the home gateway system by use of a remote personal computer, he or she has to have the remote personal computer hooked up to the main control unit 600 through the network module 300. Accordingly, the network module 300 has to be turned on all day long to support such remote controls.

The main control unit 600 performs overall control of the components of the home gateway system, that is, the broadcast reception module 100, video/audio module 200, network module 300, and home network module 400, and controls data flows among the individual function modules 100 to 400.

For example, if a user wishes to watch a broadcast program received by the broadcast reception module 100, the user has a broadcast signal, which is outputted from the broadcast reception module 100, applied to the video/audio module 200, or monitors operation states of home electronic products connected to the home network module 400. Further, the main control unit 600 is provided with driver programs for setting the respective function modules 100 to 400 to a standby state. The standby state refers to a state in which the function modules consume only minimum power for their activations and remain ready to operate immediately upon a user's demands. The standby state is not a state of complete power cutoff, but operates only minimum circuits for responding to commands of the main control unit 600. For example, in a case that the main control unit 600 sets the video/audio module 200 to the standby state, the main control unit 600 applies to the video/audio module 200 information on an input format such as MPEG, NTSC, composite signals, and so on, information on whether or not a Dolby Surround function is used, sound volume information, aspect ratio information such as a 4:3 aspect ratio, a 16:9 aspect ratio, and so on, and the main control unit 600 has to be loaded with a driver program to recognize the hardware characteristics of the video/audio module 200. The main control unit 600 stores into a register (not shown) of the video/audio module 200 information on an input format such as MPEG, NTSC, composite signals, and so on, information on whether or not the Dolby Surround function is used, sound volume information, aspect ratio information, and the main control unit 600 automatically runs the driver program to control a function module corresponding to a control signal applied to the signal input unit 500.

Further, the main control unit 600 has a program therein to check the operation states of the individual function modules 100 to 400 connected thereto. The built-in program checks the respective function modules 100 to 400 in a predetermined interval such as a few seconds to a few tens of minutes according to a polling scheme. As a result of the check, the main control unit 600 generates control signals on_off1 and on_off2 to force inactive function modules to be turned on or off. For example, the control signal on_off1 can be structured to turn function modules on at logic “low” or off at logic “high”. In the present embodiment, the control signals are to be applied only to the broadcast reception module 100 and the video/audio module 200, so that it is preferable, but not necessary, that the control signals generated from the main control unit 600 are formed with 2 bits. Here, the control signal on_off1 is a control signal for turning the broadcast reception module 100 on or off, and the control signal on_off2 is a control signal for turning the video/audio module 200 on or off.

In the meantime, instead of turning function modules off, the main control unit 600 can set the function modules to a standby state since it takes lots of time for the main control unit 600 to normally operate the function modules later. In this case, the main control unit 600 generates 2-bit control signals stand_by1 and stand_by2 for controlling the broadcast reception module 100 and the video/audio module 200 respectively. Such operations of the main control unit 600 are decided by a control signal (not shown) applied to the signal input unit 500 through a remote controller, a mobile device, and the external network (e.g., the Internet). A user can decide whether to turn off or set to the standby state the function modules connected to the home gateway system. Herein, the control signal stand_by1 is a signal for setting the broadcast reception module 100 to the standby state, the control signal stand_by2 is a signal for setting the video/audio module 200 to the standby state, and the logic level of the control signal such as stand_by1 is changed to release the function module from the standby state. For example, if the standby state is set when the control signal stand_by1 is in logic “high”, the standby state is released when the control signal stand_by1 is in logic “low”.

The power supply 700 supplies dc power to drive the home gateway system.

The power switching unit 800 selectively cuts off power supplied to the respective function modules such as broadcast reception module 100, video/audio module 200, and so on, in response to the control signals on_off1 and on_off2 applied from the main control unit 600.

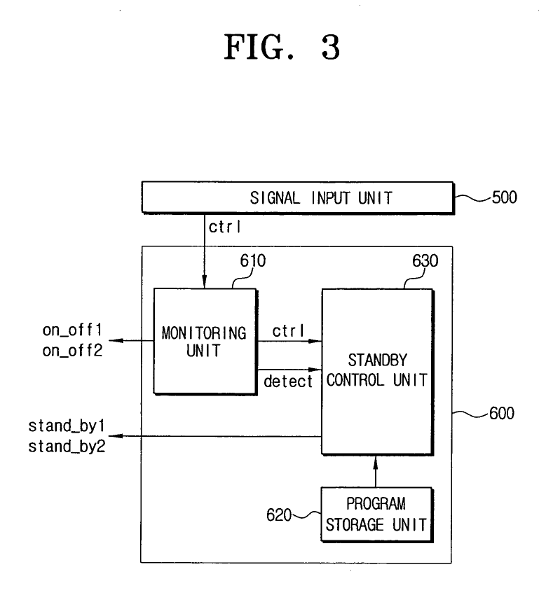

FIG. 3 is a block diagram for showing the main control unit 600 of FIG. 2 in detail.

The main control unit 600 shown in FIG. 2 has a monitoring unit 610, a program storage unit 620, and a standby control unit 630.

The monitoring unit 610 generates the control signals on_off1 and on_off2 for controlling function modules such as a broadcast reception module in response to the control signal ctrl from the signal input unit 500 or outputs the control signal ctrl applied from the signal input unit 500 to the standby control unit 630. Further, while the control signal ctrl is not applied from the signal input unit 500, the monitoring unit 610 checks operation states of the individual function modules such as a broadcast reception module, a video/audio module, and so on, in a predetermined time interval. If the function modules are found to be in the inactive state during the predetermined time as a result of the check, the monitoring unit 610 sends the check result to the standby control unit 630.

When function modules are changed to have the standby state, the program storage unit 620 stores register values necessary for the standby state. For example, in case of the broadcast reception module 100, the program storage unit 620 stores register values, that is, broadcast channel information, broadcast signal format such as NTSC, and data for sound volume setting and the like.

The standby control unit 630 switches corresponding function modules such as the broadcast reception module into the standby state in response to the control signals detect and ctrl from the monitoring unit 610. At this time, the standby control unit 630 receives from the program storage unit 620 register values for switching the function modules such as the broadcast reception module into the standby state, and outputs the register values to the function modules such as the broadcast reception module together with a control signal such as stand_by1. The function modules such as the broadcast reception module receives the register values and the control signal such as stand_by1, and changes their states into the standby state. At this time, the main control unit 600 loads a driver program for driving the broadcast reception module 100, for example. Accordingly, a user can selectively turn on or off or switch to the standby state the respective function modules 100 to 400 connected to the home gateway system, to thereby efficiently manage power to be consumed by the home gateway system.

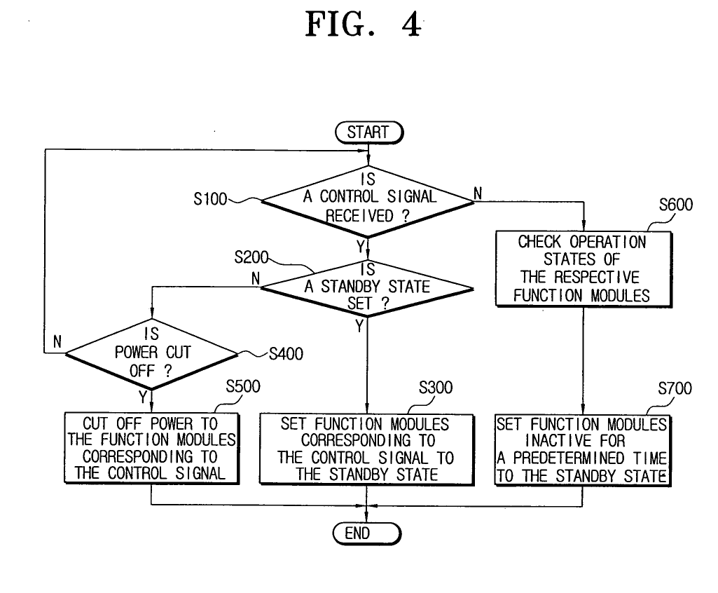

FIG. 4 is a flow chart for showing a power control method for a home gateway system according to an illustrative embodiment of the present invention.

First, the signal input unit 500 receives a wired/wireless control signal (not shown) from a device such as a remote controller, a remote personal computer, or the like. Next, the main control unit 600 decides whether the control signal ctrl applied to the signal input unit 500 is a control signal for power management for function modules such as a broadcast reception module, a video/audio module, and so on, that are connected to the home gateway system (S100). As a result of the decision, if the control signal(not shown) applied to the signal input unit 500 is a signal for power management for the function modules such as the broadcast reception module, the video/audio module, and the like, that are connected to the home gateway system, the main control unit 600 decides whether the control signal is a control signal for switching function modules such as the broadcast reception module, the video/audio module, and the like, into a standby state or for turning the same off (S200). As a result of the decision, if the control signal applied to the signal input unit 500 is a control signal for switching the same into the standby state, the main control unit 600 has the corresponding function modules switched into the standby state (S300). To release the function modules from the standby state, the main control unit 600 changes the logic level of the control signal such as stand_by1. For example, if the standby state is set when the control signal is in logic “high”, the standby state is released when the control signal stand_by1 is in logic “low”.

In the meantime, if the control signal ctrl applied to the signal input unit 500 is decided to be a control signal for cutting off power to be supplied to the function modules (S400), the monitoring unit 610 applies to the power switching unit 800 the control signals on_off1 and on_off2 for cutting off power for function modules corresponding to the control signal ctrl (S500). Next, if the signal input unit 500 is not supplied with a control signal for power management of the home gateway system, the monitoring unit 610 checks operation states of the respective function modules such as the broadcast reception module, the video/audio module, and so on, in a predetermined time interval such as a few seconds to a few tens of minutes (S600). As a result of the check, if the function modules are found to be in an inactive state for a predetermined time, the monitoring unit 610 decides that the inactive function modules are not to operate any further, and cuts off power applied to the function modules (S700). Accordingly, even though a control signal for power management is not applied to the signal input unit 500, the home gateway system can prevent unnecessary power consumption.

As stated above, the present invention can selectively turn off or on individual function modules provided for a home gateway system, and set or release inactive function modules to or from the standby state.

Various illustrative embodiments of the present invention have been described, and it will be understood by those skilled in the art that the present invention should not be limited to the described embodiments, but various changes and modifications can be made within the spirit and scope of the present invention as defined by the appended claims.

What is claimed is:

1. A home gateway system having a power management function that includes one or more function modules for controlling electrical and electronic products at home by function and a power supply for supplying electric power to the one or more function modules, comprising:
a signal input unit for externally receiving a control signal;
a control unit for generating a power control signal for controlling the power applied to respective ones of the function modules in response to the control signal, generating a standby setting signal for setting the respective function modules to a standby state, and selectively applying the standby setting signal to the respective function modules; and
a power switching unit for turning the respective function modules on or off in response to the power control signal.

2. The home gateway system as claimed in claim 1, wherein the control unit includes:
a monitoring unit for selectively applying the power control signal to the respective function modules in response to the control signal and checking operation states of the respective function modules in a predetermined time interval; and
a standby control unit for applying the standby setting signal to function modules selected based on a result of the check of the monitoring unit and the control signal applied to the signal input unit.

3. The home gateway system as claimed in claim 2, wherein the control unit has one or more driver programs for driving the respective function modules, and the driver programs are applied to the selected function modules together with the standby setting signal.

4. The home gateway system as claimed in claim 2, wherein each of the function modules has a register for setting an operation condition thereof, the driver programs are loaded into the control unit, the standby setting signal is applied to the registers of the selected function modules, and the selected function modules are set to a standby state.

5. The home gateway system as claimed in claim 1, wherein the control signal is externally generated by one of a wired control device and a wireless control device.

6. The home gateway system as claimed in claim 5, wherein the wired control device is at least one of a power setting key provided for each of the function modules and a remote personal computer for controlling the function modules through a network.

7. The home gateway system as claimed in claim 5, wherein the wireless control device is at least one of a remote controller, a mobile electronic device, and a remote personal computer for controlling the function modules through a wireless network.

8. A power control method for a home gateway system having at least one function module for controlling electrical and electronic products at home by function and a power supply for supplying electric power to the function modules, comprising:
receiving a control signal externally;
generating a standby setting signal corresponding to the control signal; and
selectively applying the standby setting signal to the function modules.

9. The power control method as claimed in claim 8, wherein the operation of generating the standby setting signal further includes:
checking an operation state of each of the function modules in a predetermined time interval; and
applying the standby setting signal to any inactive function modules of the checked function modules according to a result of the check.

10. A power control method for a home gateway system having at least one function module for controlling electrical and electronic products at home by function and a power supply for supplying electric power to the function modules, comprising:
receiving a control signal externally;
generating a power signal corresponding to the control signal; and
selectively applying the power signal to the function modules.

11. The power control method as claimed in claim 10, wherein application of the power signal causes a function module to be turned off.

12. The power control method as claimed in claim 10, wherein application of the power signal causes a function module to be turned on.
